(19) United States
(12) Patent Application Publication
(10) Pub. No.: US 2012/0203462 A1
(43) Pub. Date: Aug. 9, 2012

(54) PILE INSTALLATION AND MONITORING SYSTEM AND METHOD OF USING THE SAME

(75) Inventors: Wayne Dalton, Kent, OH (US); George R. Piscsalko, Rock Creek, OH (US); Paul Brinkerhoff, Akron, OH (US)

(73) Assignee: PILE DYNAMICS, INC., Solon, OH (US)

(21) Appl. No.: 13/367,521

(22) Filed: Feb. 7, 2012

Related U.S. Application Data
(60) Provisional application No. 61/440,649, filed on Feb. 8, 2011.

(51) Int. Cl. G06F 19/00

(52) U.S. Cl. 702/5

(57) ABSTRACT

A system and method of monitoring the installation of a pile in a ground surface. The system and method including the use of a portable monitoring device configured to allow real time data entry and display relating to the pile(s) being installed and having at least one data entry button for at least a portion of the data entry. The device further including a display for the display of desired data to help monitor and control the installation process.

This application claim priority in U.S. Provisional Patent Application Ser. No. 61/440,649 which was filed on Feb. 8, 2011 (PDY-34164) which is incorporated by reference herein.

The invention of this application generally relates to the installation of a pile structures into a ground surface. More particularly, the invention of this application relates to a monitoring system used to evaluate one or more installation parameters to assist in the installation of a pile structure into a ground surface and the certification of thereof. Further, the invention of this application relates to a method of using this pile monitoring system.

### INCORPORATION BY REFERENCE

Systems used to monitor the installation of a pile have been around for a number of years. McVay et al.—U.S. Pat. No. 6,533,502 discloses a wireless apparatus and method for analysis of piles which is incorporated by reference herein for showing the same. In addition, Mullins et al.—U.S. Pat. No. 6,783,273 discloses a method for testing integrity of concrete shafts which is also incorporated by reference in this application for showing the same. Piscsalko et al.—U.S. Pat. No. 6,301,551 discloses a remote pile driving analyzer and is also incorporated by reference in this application for showing the same. Likins, Jr. et al.—U.S. Pat. No. 5,978,749 discloses a pile installation recording system and is incorporated by reference in this application for showing the same. In addition, published patent application US-2011-0200068-A1 to Piscsalko discloses a pile sensing device and method of using the same which is also incorporated by reference in this application for showing the same. All of these patents and application form a portion of the specification of this application and are attached hereto.

### BACKGROUND OF THE INVENTION

Again, the invention of this application relates to the monitoring of the installation of piles in a ground surface. For many years, piles have been used to support a wide range of structures and have been found very useful for the same. However, in view of the fact that a pile plays such a critical role in the overall integrity of a structure and is difficult or impossible to repair after the structure is completed, it is important to produce a structurally sound pile and to do so with a high degree of certainty. Accordingly, those who install piles go to great lengths to ensure the integrity of the pile structure. This includes monitoring the installation of the pile into the ground surface and often over engineering both the pile design itself and the installation process associated with the pile. As a result, while quality piles are being produced, they are often more expensive than necessary for the weight to be supported.

Accordingly, over the years, steps have been taken to improve the monitoring side of the installation to help reduce the level of over engineering both of the pile design and the installation while still producing a pile that is rated higher than the site requirements. While some of these steps have been successful, there is still considerable waste and unnecessary over engineering in the industry.

### SUMMARY OF THE INVENTION

The invention of this application relates to a monitoring system and, more particularly, to a monitoring system that can be utilized to vastly improve and streamline the pile installation process to both improve information concerning the installation and to simplify the certification process for the installed pile.

More particularly, the invention of this application relates to a device and a method for using the device that improves data entry, storage and usage relating to the installation of the pile.

According to one aspect of the invention of this application, provided a portable device that is configured to allow real time data entry and the visual display of both this entered data and other parameters relating to the installation of a pile.

The portable device can include a touch screen for a wide range of uses including, but not limited to, entering data observed by a technician (either onsite or remotely), entering data observed by equipment (onsite or remotely), viewing automatic data acquisition, viewing results of data acquisition and operating the portable device including the set up of the device for receiving data along with other functions that may be found to be useful for these operations.

According to another aspect of the invention of this application, the portable device can include wireless technology for both sending and receiving information relating to virtually any aspect of the pile installation and data management.

This portable device can be positioned onsite in a viewing position such that the technician can observe the pile installation of one or more piles. As will be discussed in greater detail below, this can be important when manual data is being entered into the system for monitoring the installation of the pile. The portable device can further include a receiver for data that is collected by sensors attached or positioned within a measurement range of the pile(s) being installed. This data can then be stored and/or evaluated such that the onsite technician or an offsite technician can provide instructions to the onsite operators concerning the pile installation including when to stop any one of the operations.

In accordance to yet even further aspect, the portable device can include body mounting hardware, such as a wrist strap, so that the portable device is securable to the operator for ease of operation.

According to even yet another embodiment, provided is a method of monitoring the installation of a pile in a ground surface including the use of the portable device.

According to even further embodiments, provided is a system for monitoring the installation of pile wherein a plurality of piles are being installed at spaced locations at a jobsite. The system includes a portable monitoring device having an outer enclosure configured to be portable and transportable by an associated technician about the jobsite and having a means for securing the device to the associated technician for the movement about the jobsite. The monitoring device further including a user interface allowing for both the input of data and the display of data, and a power store for providing an operating power to a computing system in the device. The device further including a data store for the computing system and the storage of data, the monitoring device further including a receiver for receiving data and a transmitter for transmitting data, the user interface allowing for the manual entry of data observed by the associate technician; the system further including a remote receiver at a remote location, the computing device being programmed to produce an action signal based on data received, the monitoring device being configured to transmit instructions to the remote receiver when the action signal is generated.

According to certain aspects, this method includes the steps of providing the device that is configured to allow real time data entry and display relating to pile installation. The device is a portable device having at least one data entry button for at least a portion of the data entry and a display for at least a portion of the data display, the portable device further including a wireless transmitter and/or a wireless receiver for sending and/or receiving data respectively.

These and other objects, aspects and advantages will become apparent from the following description taken together with the accompanying drawings and documents that have been incorporated by reference into this application.

### BRIEF DESCRIPTION OF THE DRAWINGS

FIG. 1 is a schematic overhead view of a job site.

FIG. 2 is a perspective view of a portable device according to certain aspects of the invention of this application.

FIG. 3 is a screen shot for the portable device shown in FIG. 2 showing a Project Information page;

FIG. 4 is a screen shot for the portable device shown in FIG. 2 showing a Drilling status page;

FIG. 5 is a screen shot for the portable device shown in FIG. 2 showing a Project Summary page;

FIG. 6 is a screen shot for the portable device shown in FIG. 2 showing a Home page;

FIG. 7 is a screen shot for the portable device shown in FIG. 2 showing a Grout Profile page;

FIG. 8 is a screen shot for the portable device shown in FIG. 2 showing a Filling Head page;

FIG. 9 is a screen shot for the portable device shown in FIG. 2 showing a Filling Stem page;

FIG. 10 is a screen shot for the portable device shown in FIG. 2 showing a Drilling Phase Auger page;

FIG. 11 is a screen shot for the portable device shown in FIG. 2 showing a Settings page; and,

FIG. 12 is a screen shot for the portable device shown in FIG. 2 showing a Radio Configuration page.

### DESCRIPTION OF PREFERRED EMBODIMENTS

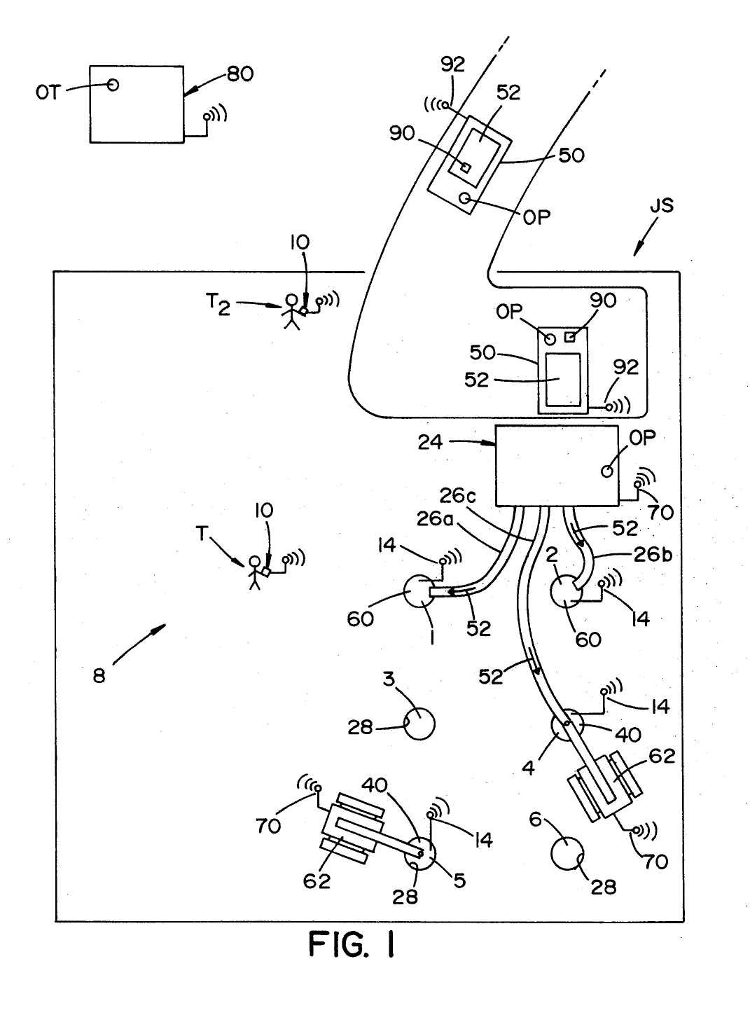

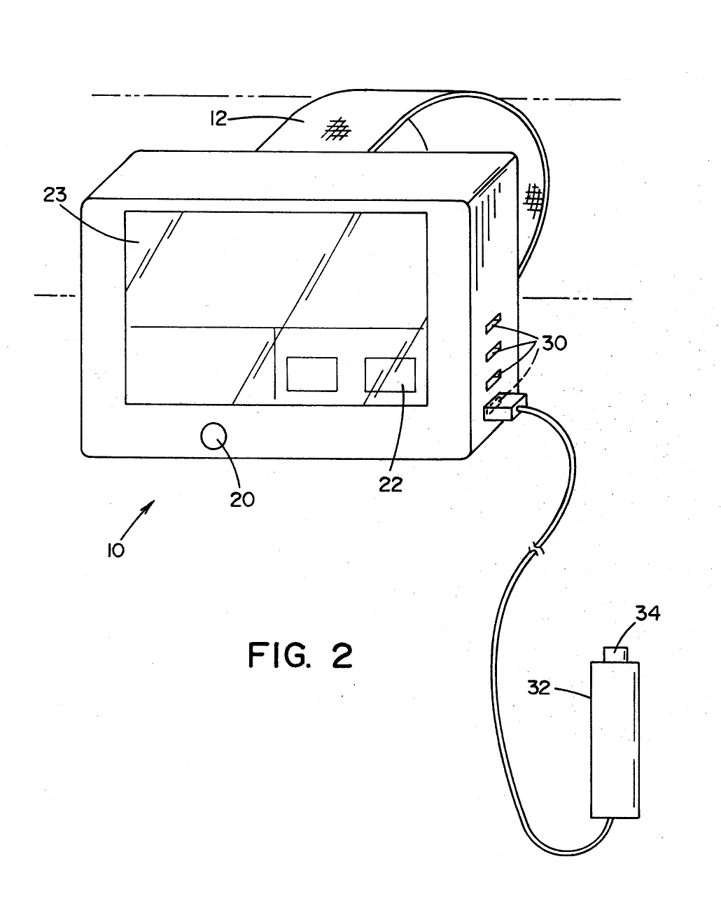

Referring now to the drawings wherein the showings are for the purposes of illustrating preferred and alternative embodiments of the invention only and not for the purpose of limiting the same, FIG. 1 shows a site plan of a jobsite JS and FIG. 2 shows a system 8 that includes a portable device 10 for use by a technician T which according to one set of embodiments, is located at jobsite JS. The remaining figures show several screen shots from portable device 10 all of which will be described in greater detail below.

Again, the invention of this application relates to monitoring system 8 and device 10 for the installation of piles along with the method of performing the same. Further, it has been found that the system and device work particularly well for auger cast piles wherein it will be described with particular reference to these cast piles. However, this application is not to be limited to auger cast piles even though they will be specifically referenced in the description below.

It is well known in the art that there are many critical aspects to the installation of a pile wherein the installation of the pile must be monitored so that the pile can be certified and so that the pile will meet the site requirements.

Over the years, there is typically an inspector and/or technician T that is hired to perform inspection operations at a jobsite. As can be appreciated, large jobsites may have more than one inspector/technician. This technician can be in charge of all aspects of the pile installation operations to primarily certify the integrity of the installed pile(s). This technician can be a contract employee hired by the installation company solely for the purpose of documenting the installation of the piles and certifying these installed piles.

In that the technician hired to monitor the pile installation operation can be responsible for several pieces of equipment, several operations and/or the installation of many piles, the control of data can be difficult, along with the control of the operations at the jobsite. While these technicians have been found to be effective in their job, improvements relating to data acquisition, data entry and data calculation can vastly improve the performance of the technician and the reliability of the data obtained.

In order to monitor this data, the technician T utilizes system 8 that includes portable device 10 in accordance with the invention of this application which can function in combination with system 8 and/or independently and which will be discussed more below.

Portable device 10 can come in many different forms and can be a mere data store, but preferably has some form of computing functions wherein the data can be both stored, utilized and/or analyzed during the pile installation operations.

In one embodiment, portable device 10 is a wrist mounted device that includes a wrist strap 12 and can be worn by technician and/or inspector T who monitors the installation of the pile(s) at jobsite JS. Further, the portable device could include any kind of strap including a neck strap that allows the technician to hang the device about his neck; even in such a way that it is viewable without being held. In this respect, the device can include an outer frame structure that orients the device such that the screen faces upwardly at an angle from the user's body so that it is viewable. Other mounting devices include, but are not limited to, arm straps, belt clips, ear mounts, and/or any device that allows easy portability and operation. Further, as will be discussed more below, the device can include one or more wired and/or wireless inputs that can be used to note an occurrence or event and/or make operation easier. Again, the system of this application is discussed in relation to a particular device configuration, but the invention of this application can come in many forms beyond wrist mounted devices. This can include, but is not limited to a heads up display, a helmet mounted device and/or a device mounted on glasses.

Portable device 10 can be a portable computing device which both receives data either in a manual form entered by technician T and/or sensor data automatically received from sensors 14 placed at or near the pile installation process which can form the system. These sensors scan be any sensors known in the art and which are described in greater detail in McVay U.S. Pat. No. 6,533,502; Mullins U.S. Pat. No. 6,783,273; Piscsalko U.S. Pat. No. 6,301,551; Likins, Jr. U.S. Pat. No. 5,978,749 and Piscsalko US-2011-0200068-A1 which are all incorporated by reference into the specification of this application. Thus, these sensors and/or systems will not be discussed in greater detail in this specification in the interest of brevity.

This provides for realtime support for operators OP of the equipment and/or systems at jobsite JS and which can be used by technician T to both store, calculate and/or disseminate data. Further, it can be used by technician T to provide instructions to any one of operators OP at jobsite JS. Even further, this data can be used to more effectively certify the pile by providing a higher quality data stream and providing realtime data evaluation.

The device and/or system can be configured in many different ways including different operation modes. As is referenced above, the data can be acquired either manually and/or automatically. As is discussed more in the patents and applications listed above, sensors can produce a wide range of data automatically, such as core temperatures of a poured grout to search for inclusions, hammer strokes and/or depth of pile installation and the like. However, it should be noted that while this application discusses use of the invention with respect to specific systems (such as augers) and specific materials (such as grout) in the interest of brevity, the invention of this application can be used with a wide variety of pile installation systems and materials wherein grout is only to be considered as an example and can include other materials such as concrete. This data can be communicated to device 10 automatically by wireless transmission and/or by wired transmission including systems that use a combination thereof. Further, this data can be displayed real time on device 10, could be displayed only under certain desired conditions (such as an alert for potential problems), could be displayable when desired and/or could be stored for future use or the like.

With respect to manually entered data, technician T can manually enter any data associated with the operation including those that could be done by sensors. In this respect, depending on a wide range of factors, it is sometimes determined that certain data is more effectively or less costly to enter manually. Essentially, manual data entry is any data that is entered based on observations (onsite or remote) that is entered by technician T and/or another worker. Automatic data entry will be referred to as sensor data and can include a wide range of automatically generated data including that which is generated by sensors positioned on or within a measurement range from the pile and/or the equipment installing the pile such as cranes, hammers, and pumping stations.

Thus, the modes of operations can include a pure manual mode, a semi-manual mode, and a fully automatic mode for both data acquisition and for the providing of instructions to onsite operators and/or technicians.

In manual mode, the technician or inspector enters all data manually into the portable device. This can be accomplished by any data entry mode known in the art including, but not limited to, voice recognition, keyboard entry, touch screen entry, and external switches and/or buttons. For example, the technician can observe the pile installation operation and hit some form of button for each pump stroke 24 being utilized to pump a desired pile material, such as grout 52, through lines 26 into the drilled holes 28. This button can be a button 20 on the portable device 10 itself and/or can be in the form of a button 22 on a touch screen 23 of portable device 10. This button can be utilized each time pump 24 strokes. Further, the portable device can include one or more data ports 30 that can be utilized to input and/or export data and further to include the capability of adding additional wired devices. These data ports can be any type of data port known in the art including, but not limited to, a Universal Serial Bus (USB) interface.

This additional wired device can include, but is not limited to, a button device 32 that can be used to manually count any parameter associated with the installation of a pile. As can be appreciated, these operations can take place over an extended period of time and in a wide range of weather conditions wherein a wired button can reduce fatigue for the technician who can keep the button within a pocket and easily rest his hand within that pocket and press a button 34 for each event being monitored. As can be also appreciated, this button can be a wireless button using any technology known in the art including, but not limited to, blue tooth technology, cellular technology and RF technology.

Another example of manual data is the logging of five foot increments for an auger 40 and/or the pumping of a grout or concrete 52 from pumping station 24. Other manual data can include, but is not limited, arrival times for a grout truck 50, grout mix information, the point at which the grout reaches the top of a hole 60 and grout flow tests.

In response to any one or more of these events, the technician can provide instructions to one or more operators OP. For example, technician T can monitor the auger cast pile installation for the grout pushing up to the ground surface (“grout return”) and manually note this event. As can be appreciated, it is difficult to electronically note this event using sensors in this type of operation. This event is important because the grout is typically over pumped into the ground. This is done to ensure that the grout is completely filling the pile hole. It has been found that the grout is often over pumped within the pile hole at a rate typically in the range of 120% to 150% of the hole size. However, depending on the soil strata, this can be even greater wherein over pumping can be as high as 300% or more. This value is determined by the removal rate of auger 40 which can be monitored by a sensor within a crane 62 handling auger 40 or any other known method of monitoring the auger advancement and/or removal rate. The volume associated with the rate of removal of the auger and the hole size can be used to determine a volumetric rate for the hole being exposed by the removal of the auger. The grout is then pumped into the pile hole at a higher volumetric rate. As a result of this excess pumping, the excess grout is forced upwardly through the flights of the auger. Eventually, grout return occurs when the excess grout traveling upwardly within the flights reaches the ground surface. This is an important event in that it indicates that the hole is being completely filled and provides confirmation on the amount of overfilling by comparing the data on pump strokes/volume and auger removal rate. It has been found that the auger can still be 40% within the hole when grout return occurs.

Once this occurs, the pumping volume is decreased and/or the removal rate of the auger is increased to drop the over pumping percentage such as a drop from 150% to 110% to reduce over pumping.

By better controlling the transition from high over pumping to lower over pumping, significant reductions in the amount of wasted grout can be realized. It has been calculated that using this invention can save approximately one cubic yard of grout per pile hole in relation to current pumping techniques. In that grout is expensive and there can be many piles at a jobsite, this is a significant savings which has not been realized before the invention of this application. In that there are often 150 to 1,500 piles at a jobsite, this savings can be between 150 cubic yards and 1,500 cubic yards per job. In that grout typically costs $60-$80 per cubic yard, this can result in a savings between $9,000 and $120,000 for these examples.

In yet another embodiment, device 10 can include a button so that technician T and/or an inspector can notify operator OP of pumping station 24 to reduce the pumping volume of grout 52 as soon as “grout return” occurs. As can be appreciated, this can quickly communicate this condition thereby saving grout. According to yet other embodiments, this can be an automatic function wherein the technicians signal can directly change the pump volume of the pump in pumping station 24.

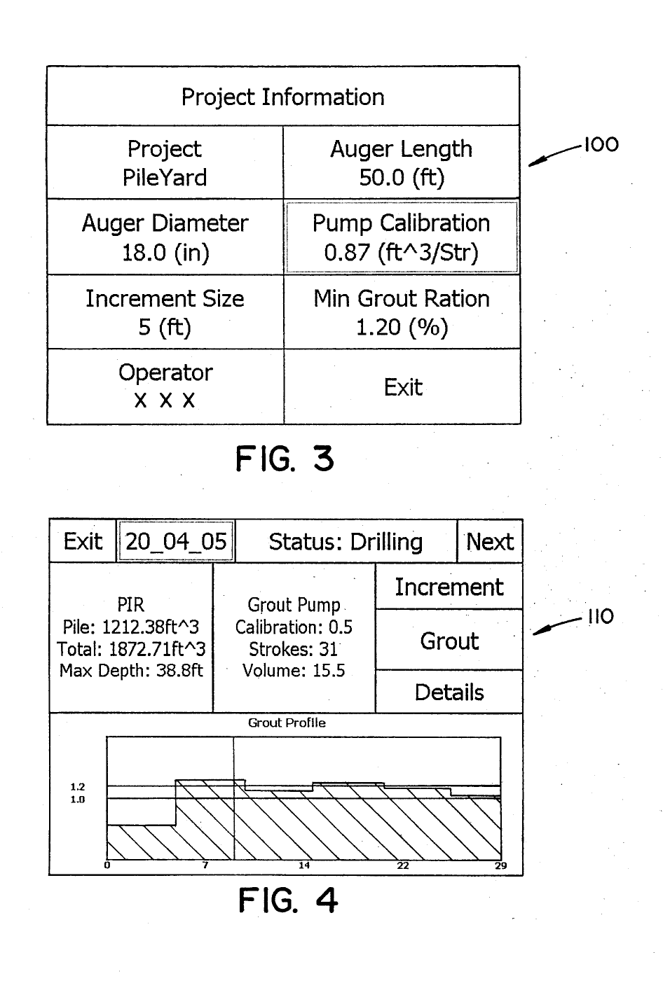

As with any of the “buttons” referenced in this specification, these buttons can be stand alone buttons, such as buttons 20 and 34, and/or can be touch screens buttons such as buttons 22 (more of which are shown in FIGS. 3-12 and discussed below). Yet even further, device 10 can include a plurality of selectable screens as are shown in FIGS. 3-12 of this application which can relate to one or more operations concerning jobsite JS. Thus, the manual operation of the “buttons” of this application can include technician T scrolling through one or more screens. Yet even further, device 10 can be programmable so that one screen shot can be configured to include touch screen buttons for the events that are to be manually documented/monitored even though they relate to different aspects of the operation wherein the secondary screens can be viewed periodically to view the data being collected and/or the status of the operation and/or certain activities.

Similarly, device 10 can include a button so that technician T notifies the crane operator to modify his particular job. This can include, but is not limited to, instructions to increase or decrease the removal rate of the auger. In this respect, the invention of this application can further include one or more remote transmitters and/or receivers 70 that can be utilized by onsite operators and/or offsite operators/technicians to form the system. In this particular example, the onsite pump operators and the onsite crane operators can include receiving device 70. Device 10 can receive any one of a number of signals including voice signals and data signals. The systems can be wireless systems and can be automatically operated by a single button stroke from the portable device operated by the technician. Again, the portable device can include a button for grout return. Once the technician pushes this button, a signal is automatically sent out to the crane operator and/or the pump operator to provide the necessary instructions. This communication can be a purely manual communication based on grout return; however, it could also be coupled to data which has been received by device 10 relating to pump stroke, grout volume, auger removal rate and the like such that the pressing of this button can initiate the calculation of data based on any one or more of these parameters such that the instructions to the crane operator and/or pump operators can be fine tuned to a specific reduction in grout volume and/or a specific increase in the auger removal rate. Yet even further, the signal can be sent automatically by device 10 based on manually entered data and/or sensor data. Again, by improving the data acquisition and the use of this data, significant cost savings can be achieved by the reduction of waste alone. However, another significant reduction in cost can be associated with the ability to reduce the over engineering of a pile by improving the data being acquired by the onsite technician.

With respect to the remote devices 70 of system 8, these can be transmitters, receivers and/or transceivers and any one or all of operators OP can be in possession one of these systems. Yet even further, devices 70 can include remote data systems such as those found in device 10 used for a wide range of information and/or data. Theses devices can include purely voice transmission using technology such as RF technology and cellular technology for instructions relating to their particular operation. This voice transmission can be either a voice transmission directly from technician T, an offsite technician OT, and/or a computer generated voice transmission based on data required from the monitoring system. In addition, the data acquired by portable device 10 can also be fully or at least partially transferred to the remote operations such as pumping station 24 that are often spaced from the actual pile installation location in that grout trucks 50 must be capable of unloading grout 52 at the pumping station. Often is the case where the trucks cannot be driven near to the pile installation due to the poor surface condition of the ground around the pile installation.

In yet other embodiments of the invention of this application, the portable device and/or a companion device can include GPS technology (or the like) to help locate the position of the pile before the pile is installed. This can include separate devices located at the jobsite to provide locating abilities.

In this respect, a jobsite that includes a significant number of piles to be installed, typically also includes a large number of workers and equipment wherein the location markers for each pile often are damaged and/or lost. When this occurs, surveyors must be called into to re-mark the location of the pile associated with the, moved, lost or damaged marker. The invention of this application can be utilized to address this occurrence, confirm the proper location of a particular pile and/or locate the position without the need for surveyors. As can be appreciated, this can provide further cost savings for the installation of the piles.

For example, in the event that a truck knocks over one or more of the markers, the portable device can be used to re-mark the pile location such that the jobsite does not need to be resurveyed. This locating feature can be performed in a many different ways. For example, a portable device that can track movement by GPS; can be used to locate the missing marker based on surrounding marks. Similarly, the site drawing could include GPS coordinates to help to locate a particular pile location. However, it is to be noted that this system and/or this application is not to be limited to GPS location technologies wherein other technologies, including, but not limited to, local positioning systems, triangulation systems utilizing radio waves or the like, cellular positioning systems, laser positioning systems and/or any other positioning systems. In yet another embodiment of this application, the onsite technician also can review the jobsite before the equipment arrives to locate and record each pile location that has been surveyed and use this information in the event that a particular pile marker is lost or destroyed or to merely confirm proper locations. Again, better information can improve jobsite efficiencies.

Yet even further, the invention of this application can include and/or calculate information on a preferred order of installation for the piles to be installed. In this respect, the invention of this application can be utilized to optimize the order in which piles are installed either by locating each pile before it is installed or by determining an optimal order to improve the efficiencies associated with the process. In one example, the preferred pattern for the installation of piles can be used to reduce the chances of overworking a given area or soil. Sometimes, there can be grout build up underground in a given location which can cause problems if it is allowed to get too large. Accordingly, the system can calculate a preferred pattern of installation to reduce these kinds of concerns.

In yet other embodiments of the invention of this application, the system and method of use of this system can include a monitoring function for the delivery of grout by grout trucks 50. As is known, the grout being delivered by truck has a limited useful life wherein after a certain period of time, the grout cannot be used. For example, grout typically needs to be used within 1.5 hours of its production or steps need to be taken to extend the life of this grout. Thus, it is advantageous to maintain a close watch on the grout trucks to make sure that only fresh grout is used in the pile pouring operation. Again, improving the monitoring of all data associated with the pile installation can reduce waste; reduce the need to over engineer, and increase efficiencies.

In this respect, the system of this application can include a number of different features to monitor the age of the grout as it is entering the jobsite. This can include manual methods to monitor the age of the grout; more particularly, the system can include a screen and/or button associated with the arrival of a grout truck. The system can then set a clock to this arrival to determine exactly how old the grout is in the particular truck to either make sure it is used in time or to take steps to add the necessary chemicals to extend its life expectancy. In yet another embodiment, the grout trucks can include a remote device which will automatically notify the technician of its arrival and/or make a data entry of the arrival within the portable device. This can be accomplished by a GPS-based system, a locally activated sensor system including proximity-like sensors, and the like. As a result, the system can automatically store data concerning the arrival and the use of grout for the pile installations. Monitoring the time in which grout is used can also be helpful for pile certification.

Yet even further, the system can include the ability to enter data relating to the testing of any grout which is received at the jobsite. This can include, but is not limited to, recording the results of any funnel testing that is used to test the grout being used at the jobsite.

In yet another embodiment of the invention of this application, the system can be used in a semi-manual mode wherein certain forms of data are gathered electronically while others are gathered manually. For example, sensors 14 located within a measurement range from the pile installation and/or equipment can be used to gather at least one of the auger displacement, the grout flow, the grout volume, the auger torque, the auger pressure, the grout line pressure, auger crowd pressure, the auger tilt, the auger removal rate and/or the stroke count for the grout pump. Manual data entry can include the stroke count of the grout pump, arrival times of the grout trucks, grout mix information, funnel testing results for the grout and/or other grout flow tests.

In the embodiments utilizing sensors for data collection, any sensors known in the art could be utilized in the system of this application. This can include wireless sensor systems and wired sensor systems.

The system and method of this application can be further practiced using a fully automatic mode. In this particular embodiment, the sensors can be utilized to generate the vast majority of the information being collected. In this particular mode, the system can further provide the instructions electronically and/or the technician can be utilized to monitor the data and provide the necessary instructions. As with all embodiments of this application, the instructions can be a blend of manual instructions and data based instructions. Further, the instructions can be modified by the data being collected by the system. Essentially, the technician could merely monitor the data being collected electronically and relay any information to other operators as is needed. This can include the reporting of the expected events of the operation and/or any unexpected events such as malfunctions. Further, the operator can add notations to the data being collected such as when grout return occurs or any other noteworthy event.

As with all of the embodiments of this application, more than one portable unit could be utilized at a jobsite either by multiple technicians or even utilized by operators at the jobsite. These separate portable devices could be merely receivers with data entry capabilities or transceivers that work in combination with a primary portable device and/or other devices.

As is shown in the schematic view of FIG. 1, a second technician T₂ can work with technician T for any number of reasons including a large number of operations or even a large jobsite configuration wherein the entire jobsite is not viewable by a single technician. In the scenario shown in FIG. 1, technician T₂ is monitoring the entry of grout trucks 50 while technician T is monitoring the remaining operations. Then, the data gathered by either technician can be communicated to both technicians, offsite technician OT and/or operators OP.

Generally, FIG. 1 shows jobsite JS that includes pile locations 1-6 wherein certain locations are in different stages of completion. Location 1 is a completed pile 60 wherein post pouring technology, such as those shown in Piscsalko US-2011-0200068, could be utilized to monitor the curing of this poured pile and this data can be electronically gathered by technician T based on the electronic communication between transmitter 14 and device 10. As will be discussed more below, a separate page or screen can be configured in device 10 to gather this data, which is segregated from other data, to allow one of the technicians to monitor and/or document the curing cycle of this pile. The same is true for location 2 wherein a poured pile 60 is in place, but which is in a different stage of curing.

With respect to locations 3 and 4, a decision can be made, based on gather data, to change the order of operation (in view of situations like over pumping the soil) such that location 3 was skipped and location 4 is in the process of being poured while location 5 is being drilled. Then, once the drilling is completed, one of lines 26, such as line 26a (which is not in use because location 1 is completed) could be moved to location 5 to begin the pouring process and these instructions can be timely communicated by technician T based on the occurrence of an event such as when the drilling is reaching the desired depth at location 5. Similarly, line 26b also could be moved as is needed to a new location in that location 2 is also completed.

In addition, any of the devices described in this application could be specially engineered devices made by applicant or others. Further, these devices could be modifications of existing or commercially available devices such as cell phones, smart phones, tablets, notebooks, and other portable computing devices and applications for use on these devices. In one embodiment, the system includes a special “app” configured on a cell phone for the implementation of the device and method of this application.

Again, the system and method of this application can be utilized to maximize the efficiency of the pile installation operation and reduce waste associated with the operation. All of these can be utilized to reduce the cost associated with pile installation and improve the quality of the installed piles. By improving data, the acquisition of data, and the communication of data, the system of this application provides the technicians and engineers a better picture of the operation in real time. Further, It also give the technician the ability to watch the details of the pile installation real time wherein in the past the inspector could not see the details until after the pile was completed and a summary report was printed. This, for many reasons, improves quality which will be appreciated by those in the art. One such example is if there is a void at a particular increment, the technician can provide instructions to one or more operators to stop and move that auger back down and re-pump that particular increment without having to waste the entire pile. Further, this real time information can be transmitted offsite such that engineers around the world can also have the benefit of the real time data being produced at the jobsite for any use.

The data collected can be used in any means known in the art including used to generate reports associated with the efficiencies of the operation and/or the integrity of the piles being produced. Further, this information can be utilized to more efficiently and effectively certify the piles once they are installed.

According to yet even other embodiments, data and/or events can be communicated to a remote site 80 that can provide one or more instructions to the jobsite and/or monitor and/or store data for current and/or future use.

According to yet other embodiments, system 8 can further include at least one grout truck circuit 90. This truck circuit can be a manual and/or an automated circuit that can help monitor grout life. In one embodiment, the circuit includes a sensor that can detect when the grout or mix is loaded into the truck. This can include a weight sensor mounted onto the suspension of the truck that detects the significant weight gain associated with loading the truck. This time can be stored and this information can be used to help determine the useful life of the grout and whether or not the useful life has been reached. As is known in the industry, the grout truck driver typically has a fixed amount of time to reach the job site and a fixed amount of time before the grout must be used or steps must be taken to lengthen the grout life. These times can be based on when the sensor notes the loading time of the grout truck. This information can then be stored for use when the truck reaches the job site and/or immediately transmitted by way of a truck transmitter 92. Further, in other embodiments, circuit 90 can be a manual circuit, such as a grout fill button, that can be operated by the truck driver and/or mix loader. Either way, this data can be used by device 10 to determine the status of grout in each truck.

With reference to FIGS. 3-12, this can include a wide range of data, analysis and information. These figures represent some examples of how the collected data can be use, but it must be clearly understood that these are examples only and should not limit the scope of the invention.

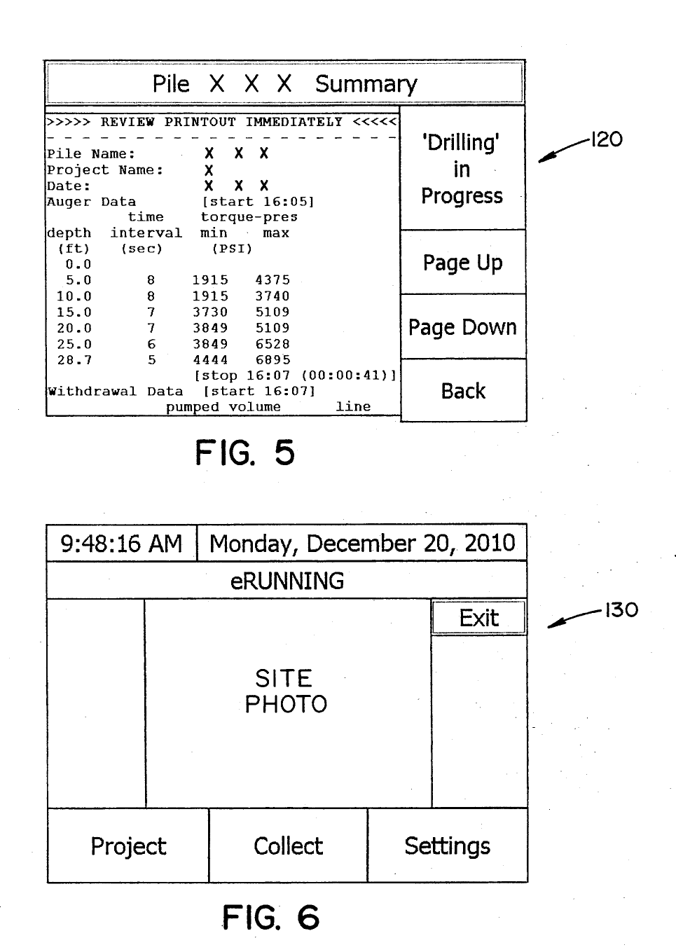

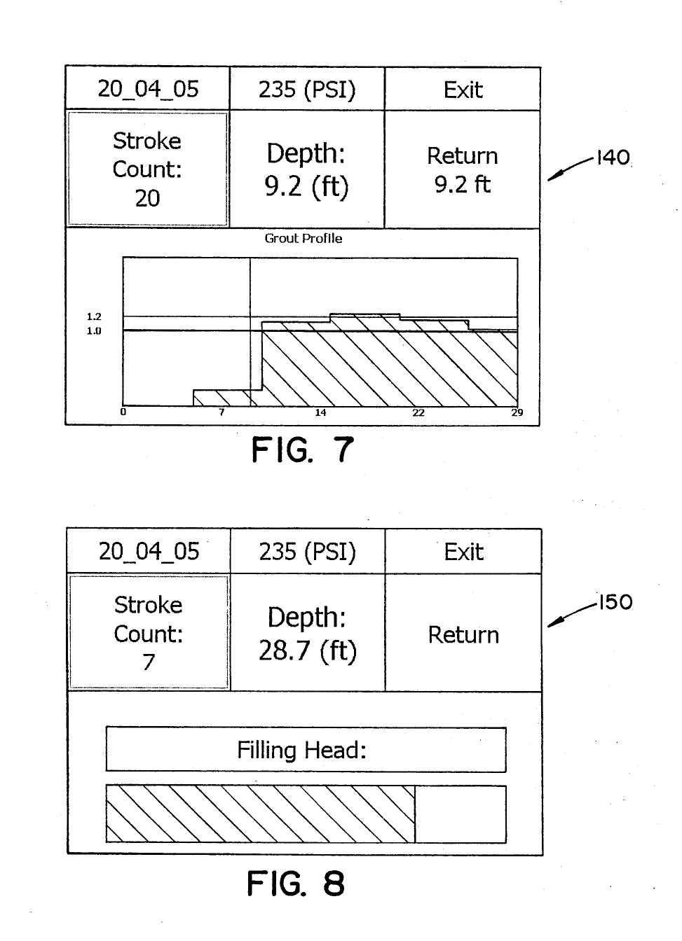

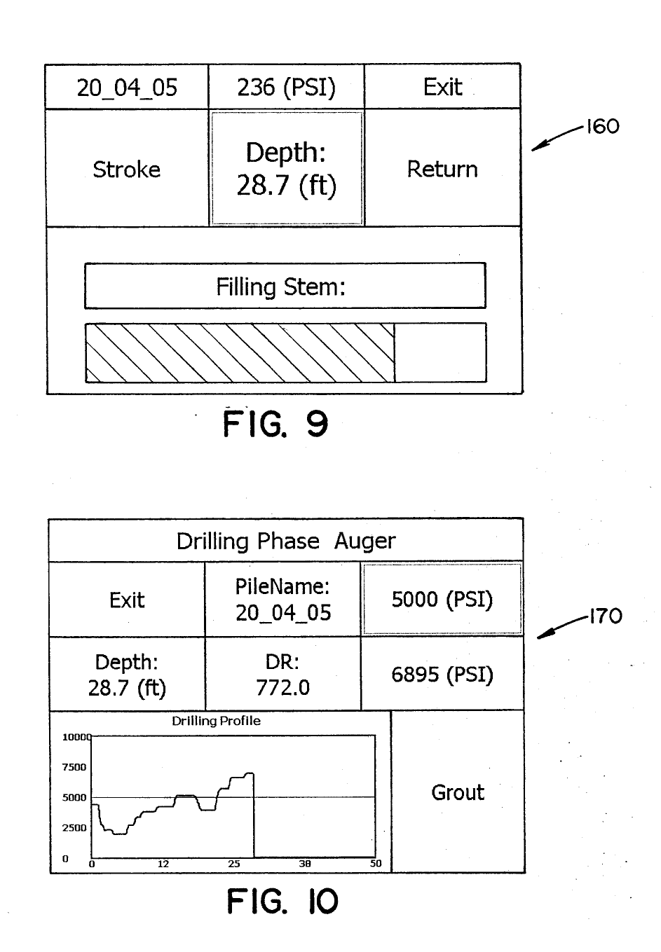

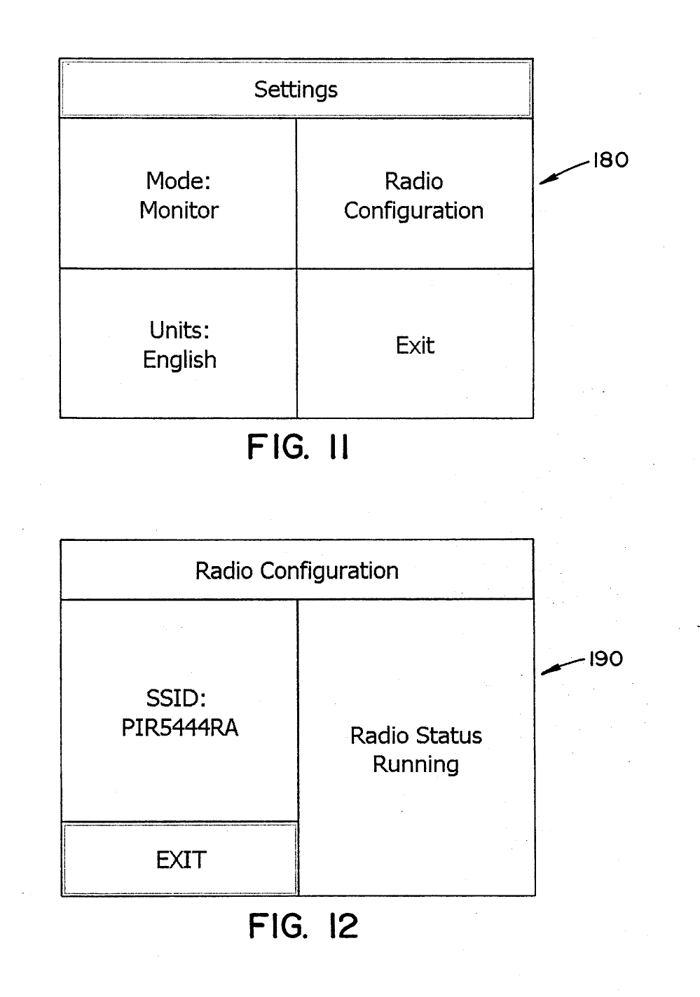

In this respect, FIG. 3 is a screen shot for portable device 10 showing a project information page 100 which can be one of the many screens displayed on screen or user interface 23. In this particular screen, shown in general project information which can be manually entered or which could be downloaded to the system by a computer (not shown) by way of the data ports 30. In that screen 23 can be a touch screen interface, any of these marked section can also be a button 22 as was discussed above. When any of these marked sections are used at a button, they can call up other screens, including but not limited to, data entry screens having a touch key pad (not shown) or transition into another screen for data entry. FIG. 4 shows a Drilling status page 110 that shows a grout profile for the particular pile being monitored and which includes data on volume and strokes. FIG. 5 shows a Project Summary page 120 that can be used to summarize any particular operation and/or pile data. FIG. 6 is a Home page 130. FIG. 7 is a Grout Profile page 140 that can include a stroke count for the grout pump and data on the depth of the auger and/or grout pump exit port. FIG. 8 is a Filling Head page 150 that can include a stroke count and depth for the filling head. FIG. 9 is a Filling Stem page 160 that can include a stroke count and depth for the filling stem. FIG. 10 is a Drilling Phase Auger page 170 that can include auger depth, pressures and a drilling profile. FIG. 11 is a Settings page 180 wherein one or more settings for the system can be made. FIG. 12 is a Radio Configuration page 190 that can be used to set the wireless communications and/or turn them on or off.

As can be noticed in these screen shots, overlapping information can be included in multiple screens such as the grout profile can be shown in more than one screen. However, this should again not be interpreted as limiting in that any information could be shown in multiple screens without detracting from the invention of this application.

Wireless transmissions relating any aspect of this invention can include any wireless transmission systems known in the art including, but not limited to, blue tooth technology, cellular technology, satellite technology, GPS, radio wave technology, internet communication, Zigbee, mesh networks and/or WiFi.

While considerable emphasis has been placed on the preferred embodiments of the invention illustrated and described herein, it will be appreciated that other embodiments and/or equivalence thereof can be made and that many changes can be made in the preferred embodiments without departing from the principles of the invention. Accordingly, it is to be distinctly understood that the foregoing descriptive matter is to be interpreted merely as illustrative of the invention and not as a limitation. Further, the wording portable should not be overly limited.

It is claimed:

1. A method of monitoring the installation of piles in a ground surface of a jobsite, the method including the steps of:
providing a portable monitoring device having a outer enclosure configured to be portable and transportable by a technician about the jobsite, the monitoring device further including a user interface allowing for both the input of data and the display of data, the monitoring device having a means for securing the device to the associated technician for the movement of the technician and the device about the jobsite, the monitoring device further including a power store for providing the needed power to operate an operating system in the device, the device further including a data store for the operating system and the storage of monitoring data, the monitoring device further including a receiver for receiving data and a transmitter for transmitting data, the device allowing for real time data entry and display relating to the installation of one or more piles and control of the operations at the jobsite;
securing the portable device relative to the technician such that the portable device moves with the technician;
moving the device into one or more monitoring locations at the jobsite;
receiving data concerning the installation of one or more piles;
entering the received data into the operating system;
determining when an event has occurred that requires action; and,
transmitting at least one of an instruction and data relating to the event.

2. The method of monitoring of claim 1, wherein the receiving data includes visually receiving data and the entering data is manually entering data by the technician using the user interface.

3. The method of monitoring of claim 2, wherein the visually received data includes at least one of a stroke count of the grout pump, arrival times of the grout trucks, grout mix information and results of grout flow test.

4. The method of monitoring of claim 3, wherein transmitting one or more instructions includes transmitting instructions to at least one of a crane operator, a grout operator, a grout truck driver.

5. The method of monitoring of claim 1, wherein the receiving data includes receiving data for more than one operation and the device having more than one separate screen page.

6. The method of monitoring of claim 1, wherein the system further includes one or more remote receivers located at onsite operations and the transmitter being in communication with the one or more remote receivers, the transmitting one or more instructions relating to the event including wireless communication by way of the wireless transmitter of the portable device and the remote receiver.

7. The method of monitoring of claim 1, wherein the system further includes at least one sensor and the method further includes the step of positioning the at least one sensor within a measurement range of a pile being installed, the portable device receiving sensor data from the at least one sensor concerning at least one parameter relating to the pile installation, the entering step including entering the sensor data automatically.

8. The method of monitoring of claim 7, wherein the sensor data includes receiving at least one of auger displacement, grout flow, grout volume, grout feed rate, auger torque, grout line pressure, auger crowd pressure, auger tilt, auger advancement rate, temperature readings from one or more thermal sensor embedded in the pile, and stroke count of the grout pump.

9. The method of monitoring of claim 8, wherein the data further includes at least one of stroke count of the grout pump, arrival times of the grout trucks, grout mix information, point at which grout reaches top of the hole and grout flow test.

10. The method of monitoring of claim 1, further including the step of certifying that the pile has met the site parameters based on the at least one of the entering data step and the transmitting step.

11. The method of monitoring of claim 1, the event is a viewable event.

12. The method of monitoring of claim 1, the event is a prompt from the portable device.

13. The method of monitoring of claim 1, further including the step of positioning one of more video device and the receiving data step including receiving data from the video device.

14. The method of monitoring of claim 1, wherein the portable device further includes at least on input port, the at least one input port including video input and the monitoring step further includes storing at least one image of the pile installation.

15. The method of monitoring of claim 1, further including the step of selectively storing data from the entering step.

16. The method of monitoring of claim 1, wherein the portable device further includes a locating function, the method further including the step of locating the desired location of a pile by way of the locating function of the portable device and marking the desired location.

17. The method of monitoring of claim 1, wherein the locating function is at least one of GPS based, cellular based, local triangulation based.

18. The method of monitoring of claim 1, further including the step of calculating a preferred order of installation for the piles to be installed by using data received from the receiving step.

19. The method of monitoring of claim 1, wherein the portable device further includes a wrist strap and the securing step to secure the portable device relative to the technician includes using the wrist strap to secure the device to the wrist of the technician.

20. The method of monitoring of claim 1, wherein the user interface includes a touch screen for at least a portion of the data entry and at least a portion of the data display.

21. The method of monitoring of claim 20, wherein the portable device further includes at least one data button separate from the touch screen.

22. The method of monitoring of claim 21, wherein the portable device includes a separate display unit.

23. The method of monitoring of claim 1, wherein the portable device further includes at least one data port.

24. The method of monitoring of claim 23, wherein the portable device further includes a remote data entry device connectable to the at least one data port and in communication with the portable device for at least one data entry function.

25. The method of monitoring of claim 24, wherein the remote data entry device includes a push button for entry of at least one of the data and the event.

26. The method of monitoring of claim 1, wherein the transmitting step includes transmitting data to a long term data store relating to the event.

27. The method of monitoring of claim 26, wherein the long term data store is at a remote location.

28. The method of monitoring of claim 26, wherein the long term data store is in the monitoring device.

29. The method of monitoring of claim 26, further including the step of certifying that the pile has met the site parameters based on the data from the long term data store.

30. A system for monitoring the installation of pile wherein a plurality of piles are being installed at spaced locations at a jobsite, the system comprising a portable monitoring device having a outer enclosure configured to be portable and transportable by an associated technician about the jobsite and having a means for securing the device to the associated technician for the movement about the jobsite, the monitoring device further including a user interface allowing for both the input of data and the display of data, a power store for providing an operating power to a computing system in the device, the device further including a data store for the computing system and the storage of data, the monitoring device further including a receiver for receiving data and a transmitter for transmitting data, the user interface allowing for the manual entry of data observed by the associate technician; the system further including a remote receiver at a remote location, the computing device being programmed to produce an action signal based on data received, the monitoring device being configured to transmit instructions to the remote receiver when the action signal is generated.

31. The system of claim 30, further including at least one sensor positioned within a measurement range of an associated operation for an associated pile being installed at the jobsite, the portable device being configured to receive sensor data from the at least one sensor concerning at least one parameter relating to the associated operation and the computing system being configured to segregate and store the sensor data and manually entered data.

32. The system of claim 31, wherein the remote location is at the associated operation.

33. The system of claim 31, wherein the associated operation is a first associated operation and the remote location is at a second associated operation.

34. The system of claim 30, wherein the remote receiver is offsite and data is transmitted.

35. The system of claim 30, further including at least one grout truck circuit, the grout truck circuit noting at least one of a loading time of the loading of an associated mix in a an associated grout truck and an arrival time of the grout truck at a designated location.
